(19) United States
(12) Patent Application Publication
(10) Pub. No.: US 2025/0242318 A1
(43) Pub. Date: Jul. 31, 2025

(54) POWER MANAGEMENT SYSTEM AND METHOD FOR FLUID AGITATION DEVICE

(71) Applicant: Triad Capital Group, LLC, Cleveland, OH (US)

(72) Inventors: Philip E. Rankin, Chagrin Falls, OH (US); Jorge Zapata, Cleveland, OH (US)

(21) Appl. No.: 19/037,855

(22) Filed: Jan. 27, 2025

Related U.S. Application Data
(60) Provisional application No. 63/625,082, filed on Jan. 25, 2024.

(51) Int. Cl. B01F 35/222; B01F 27/906; B01F 35/212; B01F 35/32; H02J 1/08

(52) U.S. Cl. CPC B01F 35/222; B01F 27/906; B01F 35/212; B01F 35/32025; B01F 35/3204; H02J 1/084

(57) ABSTRACT

One or more techniques and/or systems are disclosed for a fluid agitation device. The device includes a housing, a motor, and a controller. Further, the device includes a means for coupling a mixing shaft to the motor. The housing may include a first port and a second port to receive power from a first power source and a second power source, respectively. The motor is arranged within the housing and configured to receive the power. The first power source is an external power source, and the second power source is an external battery source. A controller is coupled to the motor and configured to operate the motor to rotate the mixing shaft and mix a liquid. The controller is configured to select whether the motor receives power from the first power source or the second power source.

### BACKGROUND

Intermediate bulk containers are industrial-sized containers configured to house tens to hundreds to thousands of gallons of liquid material. These intermediate bulk containers are durably designed to withstand stacking and transport via large equipment such as a forklift. The liquid material housed in the containers may need to be mixed as part of its manufacturing process or due to the separation of components in the liquid material over time from storage. To do so, a fluid agitation device may be inserted into an intermediate bulk container to agitate and mix the components of the liquid material to form a homogenous solution.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a fluid agitation device is disclosed which comprises a housing, a motor, and a controller. Further, the device includes a means for coupling a mixing shaft to the motor. The housing may include a first port and a second port to receive power from a first power source and a second power source, respectively. The motor may be arranged within the housing and may be configured to receive the power. The first power source may be an external power source, and the second power source may be an external battery source. A controller may be coupled to the motor and may be configured to operate the motor to rotate the mixing shaft and mix a liquid. The controller may be configured to select whether the motor receives power from the first power source or the second power source.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 illustrates a partial perspective view of some implementations of an intermediate bulk container with a fluid agitation device as disclosed herein.

FIG. 2A illustrates a side view of some implementations of the fluid agitation device as disclosed herein.

FIG. 2B illustrates another side view of some implementations of the fluid agitation device as disclosed herein.

FIG. 3A illustrates a side view of some implementations of the fluid agitation device that is not connected to an external battery as disclosed herein.

FIG. 3B illustrates a cross-sectional view of some implementations of the fluid agitation device as disclosed herein.

FIG. 4 illustrates a side view of some implementations of the fluid agitation device that is not connected to an external power supply as disclosed herein.

FIGS. 5A and 5B illustrate magnified views of an external power supply connector as disclosed herein.

FIG. 6 illustrates a flow diagram of some implementations of a method of powering the fluid agitation device via an external power supply.

FIG. 7 illustrates a flow diagram of some implementations of yet another method of powering the fluid agitation device using external battery and power supply.

FIG. 8 illustrates a flow diagram of some implementations of a method of powering the fluid agitation device via battery power when other power supplies fail or are disconnected.

FIG. 9 illustrates a flow diagram of some implementations of another method of powering the fluid agitation device via battery power when other power supplies fail or are disconnected.

FIGS. 10A, 10B, and 10C illustrate various views of some implementations of a drum bracket that may receive the fluid agitation device as disclosed herein.

FIGS. 11A, 11B, and 11C illustrate various views of some implementations of an open container C-clamp that may receive the fluid agitation device as disclosed herein.

FIG. 12 illustrates a perspective view of some implementations of a bridge connector that may receive the fluid agitation device as disclosed herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The disclosed power management system and corresponding fluid agitation device may be used with intermediate bulk containers in a variety of industries such as, but not limited to, agriculture, chemical, container, construction, food and beverage, industrial, manufacturing, coatings, lawncare, oil and gas, personal care, adhesives, polymers, water treatment, and other similar industries. The disclosed fluid agitation device provides a portable, low weight, and modular system to, for example, keep a solid within a suspension in a liquid; mix liquids that have separated overtime; mix liquids in harsh environments; mix liquids in remote locations; mix liquids with a lower input voltage requirement; mix liquids even when there is a power outage; monitor real-time parameters during mixing; initiate mixing while an operator is not near the container; achieve mixing with only one operator; mix a liquid without high speed shearing; mix within a non-circular container; and interface with a variety of commercially available mixing and container components.

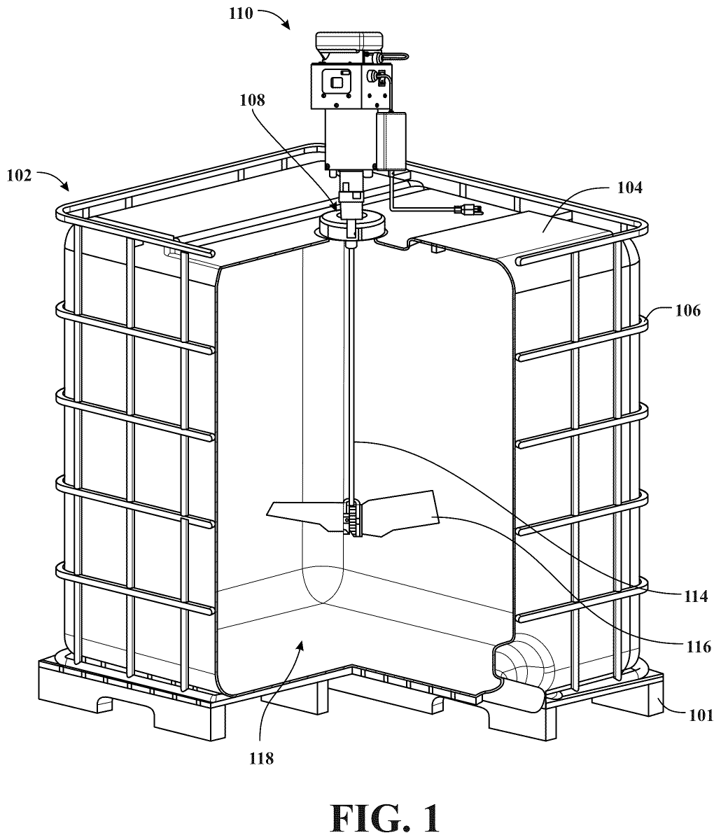

FIG. 1 illustrates a perspective view of some implementations of an intermediate bulk container 102 comprising some implementations of a fluid agitation device 110 as disclosed herein.

The intermediate bulk container (IBC) 102 may comprise a main housing 104 that defines a chamber 118 configured to hold a liquid material (e.g., a solution, a colloid, a slurry, a viscous material, etc.). A portion of the main housing 104 is removed at the front of FIG. 1 such that the chamber 118 and components therein of the IBC 102 can be viewed. It will be appreciated that the main housing 104 would actually be a closed housing and the chamber 118 would not actually be visible in a commercial IBC 102.

To reduce weight and cost, the main housing 104 may comprise a plastic material or some other lightweight material, for example a light weight metal. To increase the rigidity of the main housing 104, a protective cage structure 106 may be arranged along outer surfaces of the main housing 104. In some implementations, the protective cage structure 106 comprises aluminum, steel, a thermoplastic, a composite, or some other suitable lightweight, rigid, and strong material. The main housing 104 and the protective cage structure 106 may be arranged on a pallet 101. In some implementations, the overall shape of the main housing 104, the protective cage structure 106, and the pallet 101 of the IBC 102 may be a rectangular prism for structural and storage purposes.

To access the chamber 118 and enclosed liquid, the main housing 104 may comprise one or more openings. These openings may be plugged during storage and transport and unplugged to access the chamber 118. The openings and plugs on the main housing 104 have a substantially low-profile such that they do not interfere with the stacking of the IBCs 102. To mix the housed liquid in the chamber 118, the fluid agitation device 110 may be inserted into one of the openings in the main housing 104. The fluid agitation device 110 typically does not permanently stay within the IBC 102 due to cost of the fluid agitation device 110, space and weight constraints of the overall IBC 102, and maintenance of the fluid agitation device 110. Thus, the fluid agitation device 110 can be used in various containers.

As shown in FIG. 1, for example, the IBC 102 comprises a mixing opening 108, which may be a small opening extending through the main housing 104 and configured to receive the fluid agitation device 110. A mixing shaft 114 may be coupled to the fluid agitation device 110 at a bottom of the fluid agitation device 110 proximate the mixing opening 108. In some implementations, the mixing shaft 114 is inserted into the mixing opening 108. The mixing shaft 114 may comprise blades 116 at a first end of the mixing shaft 114 arranged near a bottom of the IBC 102. In some implementations, the mixing shaft 114 may comprise several sets of blades 116 or other suitable mixing structures such as, but not limited to, a whisk.

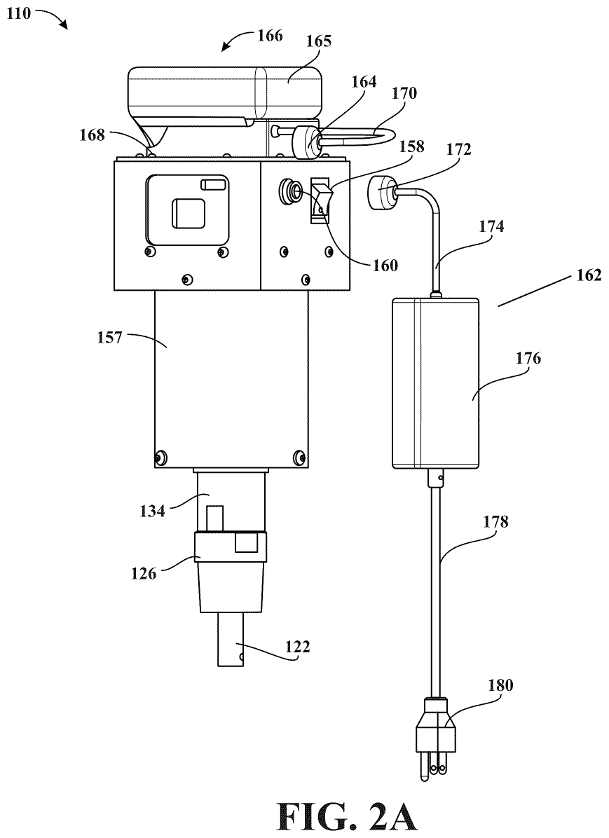

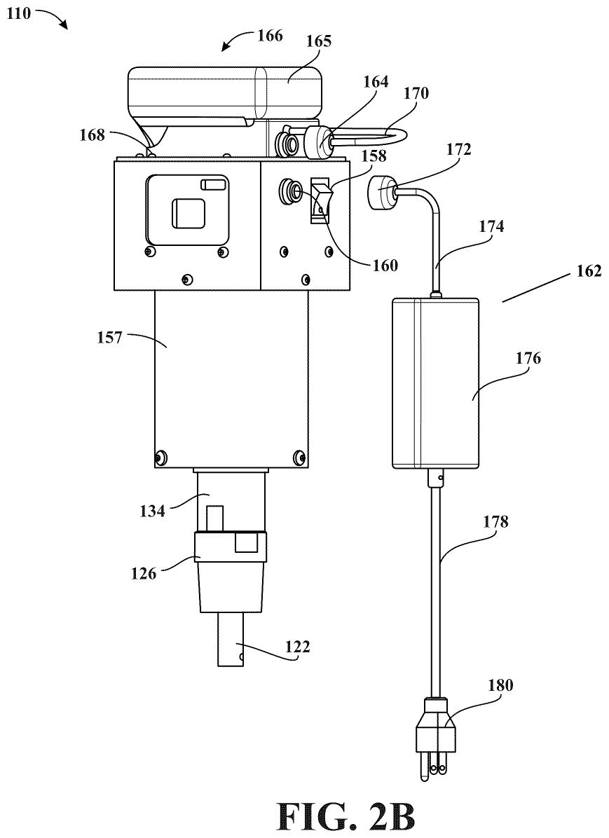

Turning additionally to FIGS. 2A and 2B, a magnified view of the fluid agitation device 110 is illustrated. The fluid agitation device 110 comprises a housing 157 that contains an electric motor and a controller. The electric motor may be coupled to drive connector 134, wherein the drive connector 134 is coupled to a start connection component 122 configured to receive the mixing shaft 114. When the motor is ON, the drive connectors 134 and the start connection component 122 begin to rotate, thereby rotating the mixing shaft 114 to mix the liquid housed in the chamber 118. The fluid agitation device 110 may further comprise a reducer component 126 arranged between the start connection component 122 and the drive connector 134. The reducer component 126 may be removable and is configured to couple the fluid agitation device 110 to a mixing opening 108. Thus, a reducer component 126 can be retrofitted such that the fluid agitation device 110 can attach to any mixing opening 108. In some implementations, for example, the reducer component 126 may be threaded or comprise some other mating connector to mate with the mixing opening 108.

In some implementations, the fluid agitation device 110 comprises an ON/OFF switch 158 allowing a user to turn the fluid agitation device 110 ON and OFF. The fluid agitation device 110 may further comprise a display panel for a user to turn the fluid agitation device 110 ON and OFF and/or for a user to control the rotational speed and pattern of the fluid agitation device 110. For example, the controller display panel may display the RPM, the time remaining in the mixing operation, or some other real-time operating parameter. These real-time operating parameters and user-input commands at the display panel and ON/OFF switch 158 may be coupled to the controller to operate the motor. In some implementations, the fluid agitation device 110 comprises hall sensors that provide location and speed information for a computer system or some other electronic monitoring device to extrapolate data and give the user feedback data such as speed, resistance, time, centipoise, and the like. The controller may be directly, wirelessly, and/or remotely controlled. For example, the motor may be turned ON and OFF by a user in a remote location from the electric motor via another computer system, remote control, phone application, or the like that is wirelessly connected to the controller.

The fluid agitation device 110 may further comprise a first port 160 configured to couple with and receive power from a first power source 162. In some implementations, the fluid agitation device 110 may be configured to couple with and receive power from a second power source 166. The first power source 162 may comprise a first power connection component 172, a power block 176, and a plug 180. The first power connection component 172 is configured to mate with and electrically couple to the first port 160 extending through the housing 157 of the fluid agitation device 110. In some such implementations, the first power connection component 172 is coupled to the power block 176 via a first wire 174, and the plug 180 is coupled to the power block 176 via a second wire 178.

The power block 176 is configured to receive power from an external power source, such as an outlet on a wall, and convert the external power to a desired voltage range for the motor and controller requirements. For example, in some implementations, the external power source may provide AC voltage to the power block 176, and the power block 176 may convert the AC voltage to DC voltage such that the controller and motor of the fluid agitation device 110 ultimately receives a DC voltage in a desired range. In some implementations, the fluid agitation device 110 operates on DC volts and in a range of between, for example, preferably approximately 5 volts to approximately 48 volts, more preferably approximately 15 volts to approximately 35 volts, or even more preferably approximately 20 volts to approximately 30 volts. Because the motor of the fluid agitation device 110 is configured to operate on volts of DC, interruptions in voltage input to the motor is reduced. Thus, the liquid can be mixed at a consistent and predictable speed by the motor. Additionally, with a low DC voltage requirement, the fluid agitation device 110 is more stable and can be powered by a variety of power sources in a variety of locations. Operators can also avoid various certification requirements typically needed for machines that operate at a high voltage threshold. In some implementations, the power block 176 is removably coupled to the fluid agitation device 110 at the first port 160 such that a different power block 176 can be used that is suitable for the external power source that is available. Further, by being removable, the fluid agitation device 110 can be transported without the entire first power source 162, thereby reducing overall weight of the fluid agitation device 110.

In some implementations, the second power source 166 comprises a battery 165 removably coupled to a dock component 168. The dock component 168 may mechanically receive and electrically couple with the battery 165. The dock component 168 may be removably coupled to a top of the fluid agitation device 110. In some implementations, a second power connection component 164 is coupled to the dock component 168 via a third wire 170. In some implementations, the second power connection component 164 is also configured to couple with and receive power from a second power source 166. Thus, the fluid agitation device 110 may receive power from the first power source 162 via the first port 160 or from the second power source 166 via the first port 160. In other implementations, the fluid agitation device 110 may comprise a second port that is different than the first port, wherein the second port is configured to couple with and receive power from the second power source 166, while the first port is configured to couple with and receive power from the first power source 162. The second port may also be part of the dock component 168 and arranged between the dock component 168 and the housing 157 of the fluid agitation device. In some such implementations, the third wire 170 and second power connection component 164 may not be externally visible when the dock component 168 is coupled to the housing 157. The second power source 166 is configured to supply DC volts to the fluid agitation device 110. Thus, the battery 165 of the fluid agitation device 110 is configured to provide DC volts to the fluid agitation device 110 in a range of between, for example, preferably approximately 5 volts to approximately 48 volts, more preferably approximately 15 volts to approximately 35 volts, or even more preferably approximately 20 volts to approximately 30 volts.

DC motors have a variable speed up to 22,500 RPM, for example. At an 85 to 1 speed drive motor to high gear ratio reduction, the electric fluid agitation device 110 has an optimum mixing speed of up to about 147 RPM, in some implementations. The disclosed electric motor drives may each weigh about 5 pounds to about 10 pounds. For example, in some implementations, an electric fluid agitation device 110 weighs about 8 pounds. Thus, the electric fluid agitation device 110 has a fairly high speed-to-weight ratio, contributing to easy and safe handling of the fluid agitation device 110.

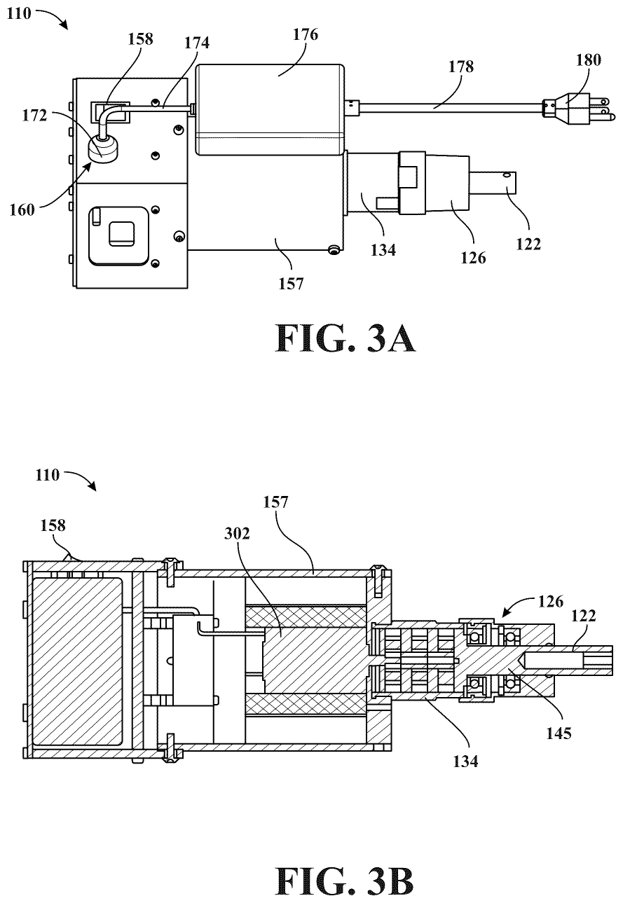

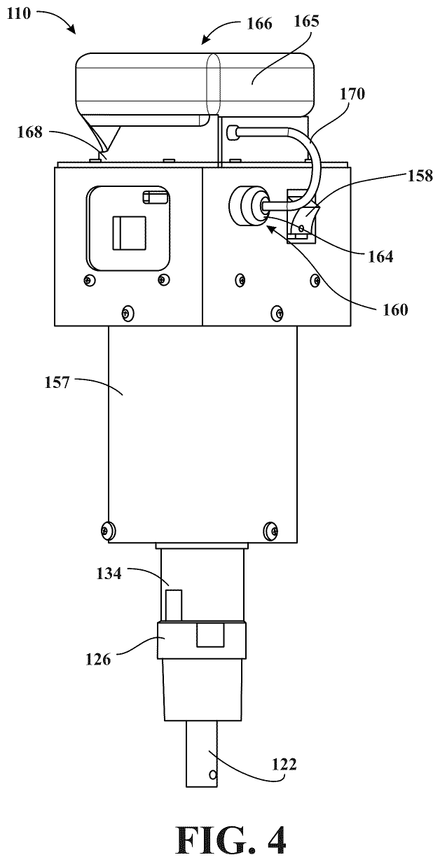

FIG. 3A illustrates a side view of some other implementations of the fluid agitation device 110. When compared to FIGS. 2A and 2B, the fluid agitation device 110 of FIG. 3A does not comprise the second power source 166. Thus, the fluid agitation device 110 is capable of being powered by the first power source 162 and not the second power source 166.

FIG. 3B illustrates a cross-sectional view of some implementations of the fluid agitation device 110. The motor 302 may be arranged within the housing 157 and coupled to the drive connector 134, wherein the drive connector 134 is engaged with the start connection component 122 to rotate the start connection component 122 and mixing shaft 114.

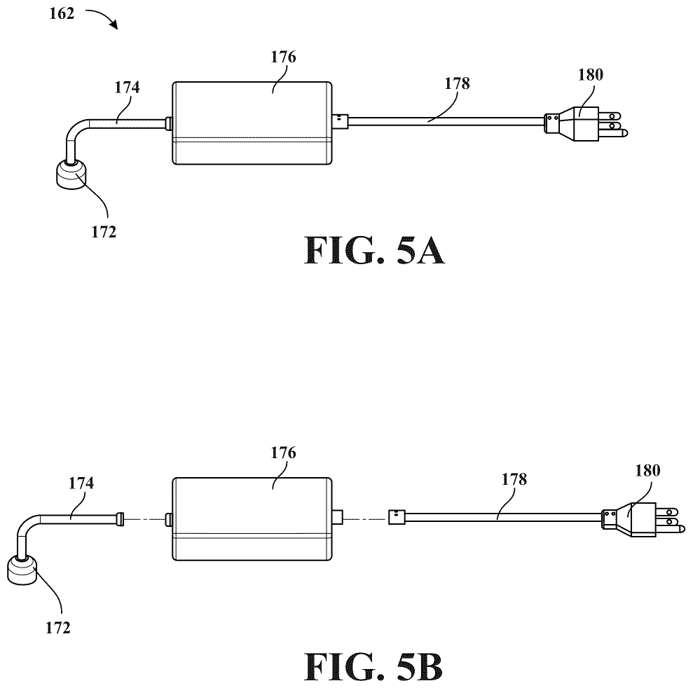

FIG. 4 illustrates a side view of yet some other implementations of the fluid agitation device 110. When compared to FIGS. 2A and 2B, the fluid agitation device 110 of FIG. 4 does not comprise the first power source 162. Thus, the fluid agitation device 110 is capable of being powered by the second power source 166 and not the first power source 162. This way, the fluid agitation device 110 can be operated in environments where a typical power source such an outlet or a large generator is not available. Because the fluid agitation device 110 requires a lower voltage, the battery 165 can provide enough power to evenly mix liquid in a chamber 118. Because the battery 165 is removable, the user of the fluid agitation device 110 can have extra fully charged batteries 165 on-site to replace the battery 165 should the charge run out before the mixing is complete. Additionally, the dock component 168 can receive various sizes of batteries 165 such that depending on the conditions and mixing time requirements, a user can choose an appropriate battery accordingly. In some implementations, the mixing time may be in a range of between about 5 minutes and about 20 minutes. Because of the low voltage requirement, the mixing cycle may be powered completely by the battery 165 during the mixing time. In some implementations, the dock component 168 can also convert the battery power to a suitable range required by the motor in the fluid agitation device.

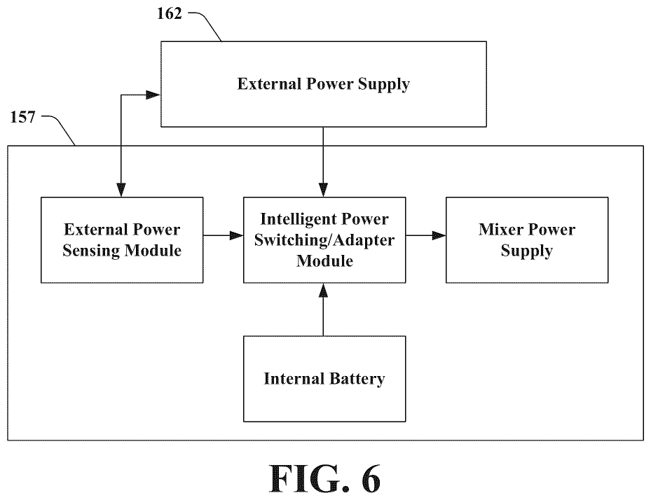

FIGS. 5A and 5B illustrate side views of the first power source 162. In particular, FIG. 5A illustrates the first power source 162, where the first power connection component 172, first wire 174, power block 176, second wire, and plug 180 are connected to one another. The plug 180 may plug into a typical hard-wired outlet, into a generator, or some other power source. As shown in FIG. 5B, the first wire 174 may be removably coupled to the power block 176 and/or the second wire 178 may be removably coupled to the power block 176. This way, different power blocks 176, outlets, and the like may be used depending on the environment and available power source for the plug 180.

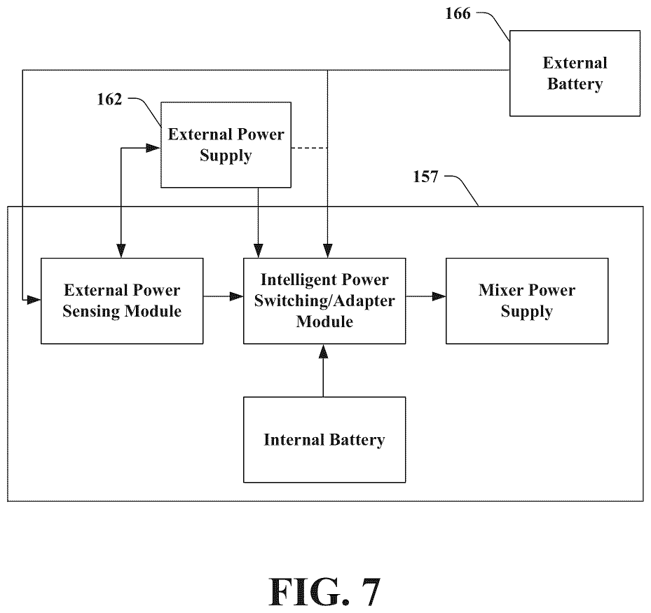

FIGS. 6, 7, 8, and 9 each represent different power management methods of the fluid agitation device 110 as described herein. Unless specified otherwise, FIGS. 6, 7, 8, and 9 will be described in conjunction with FIGS. 1 and 2. It will be appreciated that these power management methods are operated by a controller (i.e., computer system, circuitry, and the like) that is coupled to the motor and power sources 162, 166.

As shown in FIG. 6, the fluid agitation housing 157 may comprise means for an external power sensing module, which is coupled to the external power supply (e.g., first power source 162 or second power source 166) and an intelligent power switching/adapter module. The intelligent power switching adapter/module is also coupled to the external power supply, internal battery, and mixer power supply. The external power sensing module may monitor operating parameters of the external power supply such as, for example, power input and/or output. If the external power sensing module senses a change in operating parameters, such as a power input or output falling outside of some predetermined desired range, then the external power sensing module may send a signal to the intelligent power switching/adapter module. Upon receiving a signal, the intelligent power switching/adapter module may determine that the external power supply is now unreliable and switch the power input to another available power source, such as an internal battery or an external battery (e.g., 165 of FIG. 2). The intelligent power switching/adapter module is configured to receive power from each available power source and to select which power source to receive to send to the mixer power supply to power the motor 302 and ultimately, rotate the mixing shaft 114. The external power sensing module may continuously monitor the power inputs. In some other implementations, the external power sensing module may monitor parameters of the external power supply during certain predetermined time periods. In some such other implementations, some interruption in the mixing cycle may occur when the external power sensing module is not operating.

In some implementations, the housing 157 of the fluid agitation device 110 does comprise an internal battery. The internal battery may be charged occasionally using a power cord and/or may be charged during operation via the available power sources. The internal battery may be available to cover the power supply to the mixer power supply while the intelligent power switching/adapter module changes the power input to the mixer power supply. This way, there is no interruption in the power supplied to the mixer power supply. In other words, the circuitry in the fluid agitation device 110 ensures that the mixing speed is maintained at a desired mixing speed or within a desired mixing speed range.

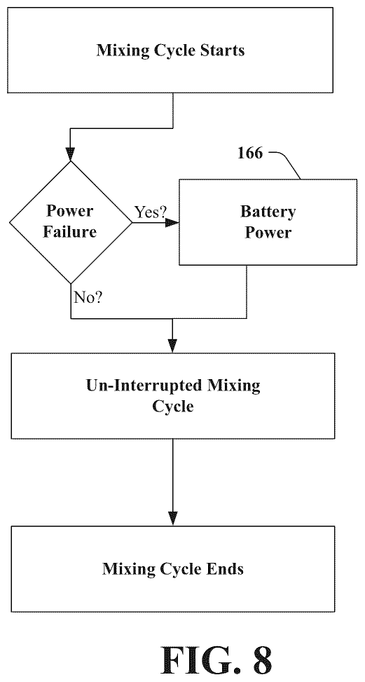

As shown in FIG. 7, the power management system of FIG. 6 may further be connected to the second power source 166 to receive power from an external battery 165. To preserve battery charge, the intelligent power switching/adapter module may favor the use of the external power source 162 before using the second power source 166. In some implementations, the external power sensing module may simultaneously sense the power status of both the external battery 165 and the external power source 162 and instruct the intelligent power switching/adapter module to utilize the external battery 165 only when the external power supply is unreliable. When the external power sensing module re-stabilizes, the external power sensing module may then instruct the intelligent power switching/adapter module to go back to using the external power supply. This monitoring cycle may be continuous while the fluid agitation device 110 is ON such that the controller can switch between the external power source 162 and the battery source 166 as needed based on the external power sensing module data collection. In some implementations, like the charging of the internal battery, the external power supply may be coupled to the external battery 165 to charge the external battery 165 while also supplying power to the mixer power supply. This way, the external battery 165 and internal battery can be recharged throughout the mixing cycle as long as the external power source 162 is still available.

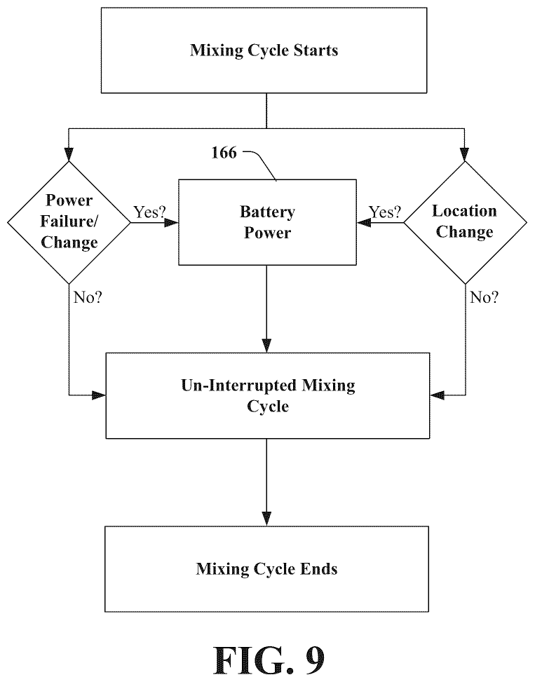

As shown in FIG. 8, a method of conducting a mixing cycle is presented. Once the controller receives a command to being the mixing cycle, the controller begins to receive power from the first power source 162 if power is available via the first power source 162. Then, when the controller senses a power failure in the first power source 162, the controller (e.g., the intelligent power switching/adapter module shown in FIG. 6 and/or alternatively in FIG. 7) may switch the power input to the second power source 166. Power failure may be indicated by a power fluctuation or simply by the power shutting off. Thus, if a power outage occurs, the mixer can continue with an uninterrupted mixing cycle due to the available battery power. By alternating to the second power source 166 (e.g., battery power) when failures in power occur from the first power source 162), the mixing cycle is uninterrupted. The monitoring of the reliability of the first power source 162 is continued until the mixing cycle is ended. The mixing cycle may end after a predetermined time or by a user input command to end the cycle.

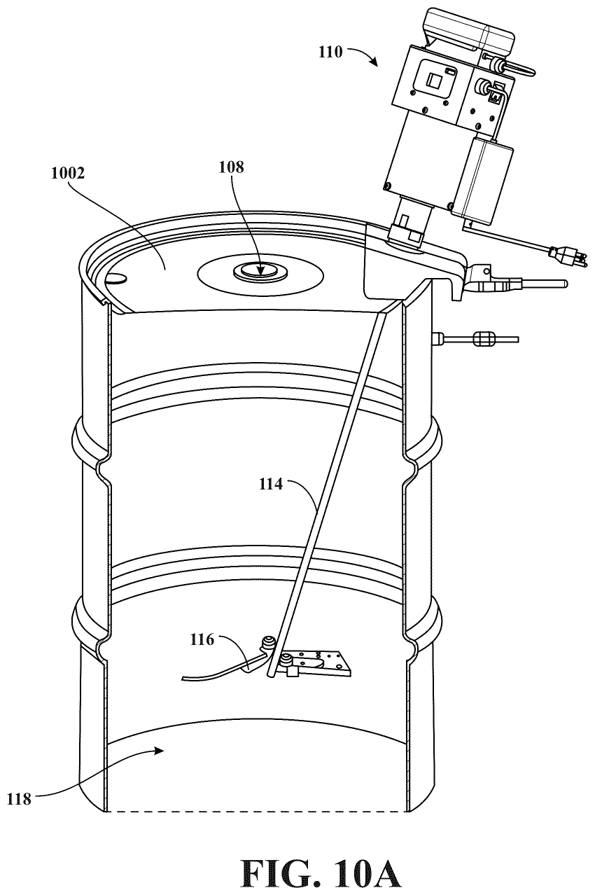

As shown in FIG. 9 the mixing cycle may also begin to use the second power source 166 (e.g., battery power) when a location change of the fluid agitation device 110 is sensed. For example, the controller may be coupled to a GPS device that monitors the location of the fluid agitation device 110. If the fluid agitation device 110 is moved a particular distance, as detected by the GPS device, the GPS device may send a signal to the controller to indicate that the location of the fluid agitation device 110 is changing. The controller may then switch the power input to the fluid agitation device 110 to the second power source 166 (e.g., battery power) so that the fluid agitation device 110 can still operate wirelessly without being tethered to some immobile power source such as an outlet in a wall or large generator. Therefore, the liquid in the chamber 118 can continue to be mixed, even if the liquid is being transported. It will be appreciated that in some other implementations, the location change may be indicated by a user input. For example, if the intermediate bulk container 102 and fluid agitation device 110 are being loaded onto a tractor to spray pesticides in a field, the user may notify the fluid agitation device 110 that the fluid agitation device 110 is about to be transported away from the first power source (e.g., 162) and is going to instead require power from the second power source (e.g., 166). Thus, the location change indication can be manually inputted or automatically detected by the controller in the fluid agitation device 110.

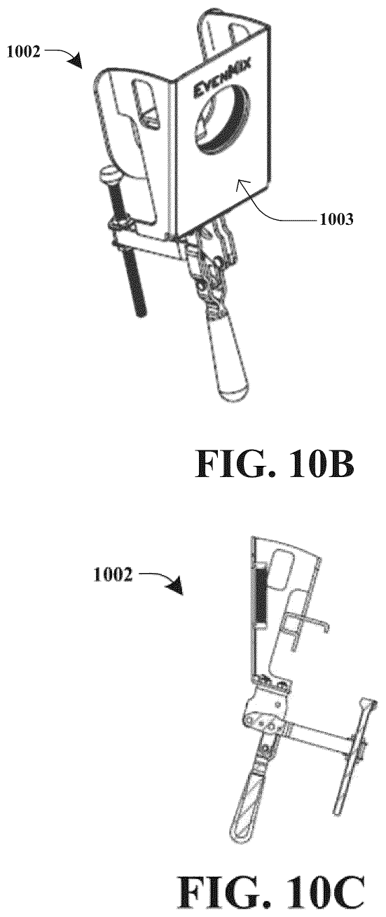

Turning additionally to FIGS. 10A, 10B, 10C, 11A, 11B, 11C, and 12, some other devices that may be compatible with the disclosed fluid agitation device 110 are presented. For example, the disclosed fluid agitation device 110 can be used in various different IBCs 102 such as open IBCs, closed IBCs, some other IBC design, drum, container, or the like. As an example, the fluid agitation device 110 may be used to mix the contents held in an IBC housing 275 gallons to 500 gallons; in a drum housing 55 gallons; in an open top container holding 30 gallons to 10,000 gallons; in a closed top container/tank holding 30 gallons to 10,000 gallons; or some other type and sized container.

In FIGS. 10A, 10B, and 10C various views of a drum bracket 1004 are illustrated for use with a drum container 1002. In some implementations, the drive connector 134 or the reducer component 126 may be threaded into an opening 1003 of the drum bracket 1004. In some other implementations, it will be appreciated that the drum container 1002 may comprise a mixing opening 108 such that the fluid agitation device 110 can attach to the drum container 1002 through the mixing opening 108 instead of a drum bracket 1004. The drum bracket 1004 may be connected to an IBC (e.g., 102 of FIG. 1), a drum container 1002, or some other large container. The drum bracket 1004 also may be coupled to the mixing shaft 114 and blades 116 such that the fluid agitation device 110 controls the rotation of the mixing shaft 114 and blades 116. In some implementations, the blades 116 may span 15 inches in diameter within a 55 gallon drum container 1002. It will be appreciated that the blades 116 may be engineered to be larger or smaller depending on the size of the drum container 1002 and mixing opening 108.

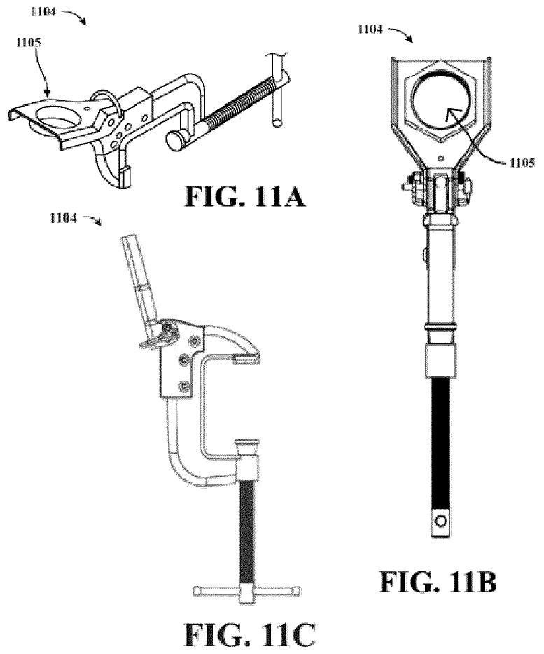

In FIGS. 11A, 11B, and 11C, various views of an open container C-clamp 1104 are illustrated. In some implementations, the drive connector 134 or the reducer component 126 may be threaded into an opening 1105 of the open container C-clamp 1104. The open container C-clamp 1104 may be connected to an IBC 102, drum container 1002, or the like and also may be coupled to the mixing shaft 114 and blades 116 such that the fluid agitation device 110 controls the rotation of the mixing shaft 114 and blades 116. In some implementations, the open container that the C-clamp 1104 is coupled to may be configured to house about 50 gallons to about 10,000 gallons of liquid. In some implementations, the open container has exposed inner sidewalls during mixing because the open container does not have a lid. The open container C-clamp 1104 can accommodate fluid agitation devices 110 having a single folding set of blades 116 or several sets of blades 116.

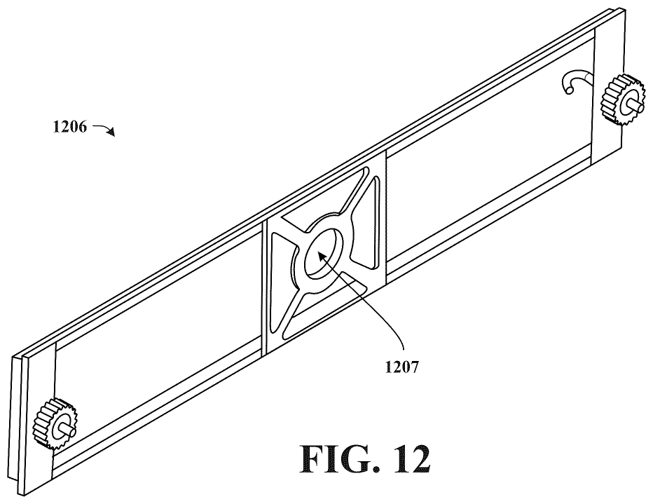

In FIG. 12, a bridge connector 1206 is illustrated. In some implementations, the drive connector 134 or the reducer component 126 may be threaded into an opening 1207 of the bridge connector 1206. The bridge connector 1206 may be connected to an IBC 102 and also may be coupled to the mixing shaft 114 and blades 116 such that the fluid agitation device 110 controls the rotation of the mixing shaft 114 and blades 116. In some implementations, bridge connector 1206 is configured to connect to the protective cage structure 106 of an IBC 102. Such a connection provides more support to the bridge connector 1206 such that the motor drive 112 can mix thick liquids. Additionally, in some implementations, if the bridge connector 1206 is only directly connected to the protective cage structure 106 of the IBC 102, a user may be able to view the liquid being mixed in real-time through the mixing opening 108 of the IBC 102.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

1. A fluid agitation device comprising:
a housing comprising a first port and a second port;
a motor arranged within the housing and configured to receive power from a first power source and a second power source, the first power source being an external power source coupled to the first port, and the second power source being an external battery source coupled to the second port;
a means for coupling a mixing shaft to the motor; and
a controller configured to operate the motor to rotate the mixing shaft to mix a liquid, wherein the controller is configured to select whether the motor receives power from the first power source or the second power source.

2. The fluid agitation device of claim 1, wherein the controller is configured to monitor the amount of power received by the motor in real-time from the first power source or the second power source.

3. The fluid agitation device of claim 1, wherein the controller is configured to select the second power source when the controller detects that a power input provided by the first power source changes.

4. The fluid agitation device of claim 1, wherein the controller is configured to select the first power source when the controller detects that a power input provided by the second power source changes.

5. The fluid agitation device of claim 1, wherein the controller is configured to rotate the motor at a predetermined speed, and wherein the controller is configured to maintain the predetermined speed when the power input to the motor changes between the first power source and the second power source.

6. A mixing system comprising:
a bulk mixing container configured to house a liquid, the bulk mixing container comprising an opening to access the liquid housed therein;
a mixing shaft surrounded extending through the opening and into an interior of the bulk mixing container;
a fluid agitation device arranged above the opening of the bulk mixing container and coupled to the mixing shaft, the fluid agitation device comprising:
a housing;
a start connection component arranged below the housing and coupled to a first end of the mixing shaft proximate the opening of the bulk mixing container;
a motor arranged within the housing, coupled to the start connection component, and configured to rotate the start connection component and the mixing shaft;
a first port extending through the housing and configured to receive a first power source;
a second port extending through the housing and configured to receive a second power source; and
a controller configured to operate the motor to rotate the mixing shaft to mix a liquid, wherein the controller is configured to select whether the motor receives power from the first power source or the second power source.

7. The mixing system of claim 6, wherein the controller is configured to rotate the motor at a predetermined speed, wherein the controller is configured to change between the first power source and the second power source based on the regularity of power provided by the one of the first or second power sources, and wherein the controller is configured to maintain the predetermined speed when to the controller changes between the first power source and the second power source.

8. A method for mixing liquid comprising:
obtaining a bulk mixing container that surrounds and houses a liquid, wherein the bulk mixing container comprises at least one opening to access the liquid from outside of the bulk mixing container;
attaching a mixing shaft to a connection component of a fluid agitation device, the fluid agitation device comprising a controller operably connected to a motor;
arranging the mixing shaft in the bulk mixing container through the opening such that the mixing shaft contacts the liquid within the bulk mixing container, wherein the mixing shaft comprises a blade and is operably coupled to the motor;
attaching a first power source to the fluid agitation device;
attaching a second power source to the fluid agitation device;
turning the fluid agitation device ON such the controller turns the motor ON using power from the first power source and the motor rotates the mixing shaft at a mixing speed;
monitoring the mixing speed using the controller;
sensing a change in condition of the fluid agitation device; and
changing, using the controller, the power input to the motor from the first power source to the second power source to continue to mix the liquid at the mixing speed.

9. The method of claim 8, wherein the change in condition is a fluctuation in the mixing speed.

10. The method of claim 8, wherein the change in condition is a change in power received by the first power source.

11. The method of claim 8, wherein the change in condition is a change in location of the fluid agitation device.

12. The method of claim 8, wherein the first power source is an external power source coupled to an outlet, and wherein the second power source is a battery.

13. The method of claim 8, wherein the first power source is a battery, and wherein the second power source is an external power source coupled to an outlet.

14. The method of claim 8, wherein the first and second power source are each configured to supply 24V or less of direct current to the motor.

15. The method of claim 8, wherein the one of the first or second power sources is an external power source comprising:
a first connection configured to electrically couple with a first power port of the fluid agitation device;
a second connection configured to electrically couple with an outlet; and
a power block arranged between the first connection and the second connection, wherein the power block is removably coupled to the first and/or second connection, wherein a first wire couples the power block to the first connection, and wherein a second wire couples the power block to the second connection.
